(19) United States
(12) Patent Application Publication
(10) Pub. No.: US 2019/0194983 A1
(43) Pub. Date: Jun. 27, 2019

(54) MOTOR VEHICLE DOOR HANDLE ASSEMBLY WITH ASSEMBLY AID

(71) Applicant: HUF HULSBECK & FURST GMBH & CO. KG, Velbert (DE)

(72) Inventor: Michael KALESSE, Ratingen (DE)

(73) Assignee: HUF HULSBECK & FURST GMBH & CO. KG, Velbert (DE)

(21) Appl. No.: 16/328,774

(22) PCT Filed: Jul. 6, 2017
(86) PCT No.: PCT/EP2017/066853

§ 371 Date: Feb. 27, 2019

(30) Foreign Application Priority Data
Aug. 31, 2016 (DE) 10 2016 010 560.7

(51) Int. Cl. E05B 79/06; E05B 81/78; E05B 85/16; H01Q 1/32; H01Q 7/08

(52) U.S. Cl. CPC E05B 79/06; E05B 81/78; H01Q 7/08; H01Q 1/3241; H01Q 1/3283; E05B 85/16

(57) ABSTRACT

A motor vehicle door handle assembly including a door handle. The door handle is equipped with at least one antenna support which receives at least one sensor plate of a capacitive proximity sensor, and the sensor plate is connected to a connection piece via contact pins in order to establish electric contacts. The sensor plate lies in the antenna support in a formfitting manner and is inserted into a groove-shaped or dovetail-shaped receiving area of the antenna support in the direction of the length of the sensor plate. The sensor plate and/or the antenna support has/have a latching connection in which the sensor plate is releasably latched in a pre-assembly position in order to allow the assembly of the connection piece on the sensor plate.

The invention relates to a motor vehicle door handle arrangement according to the preamble of claim 1. Furthermore, the invention relates to a method for producing and assembling such a motor vehicle door handle arrangement.

Such motor vehicle door handle arrangements with a handle for actuating a door of a motor vehicle are known. Moreover, arranging electronic components such as an antenna, a coil wound around an antenna for the automatic establishment of a radio connection to an external ID transponder and/or sensors in the handle, is known. The terms winding and coil are used synonymously.

The object of the invention is to provide a motor vehicle door handle arrangement, in which production and assembly is simplified.

According to the invention, this object is achieved by means of a motor vehicle door handle arrangement according to claim 1. Advantageous developments of the invention are specified in the dependent claims.

The particular advantage in the motor vehicle door handle arrangement with a handle, wherein at least one antenna carrier is arranged in the handle, which accommodates at least one sensor plate of a capacitive proximity sensor, and wherein the sensor plate is connected, via contact pins, with a connection piece for producing electrical contacts, is that the sensor plate is arranged in the antenna carrier in a form-fit manner and is inserted into a groove-shaped or dovetail-shaped receptacle of the antenna carrier in the direction of its longitudinal extension, wherein the sensor plate and/or the antenna carrier comprise(s) a latching connection, in which the sensor plate is releasably latched in a pre-mounting position, in order to make the mounting of the connection piece on the sensor plate possible.

In this pre-mounting position, it is possible to place the connection piece for producing electrically-conductive connections for the connection of the sensor plate, and in particular an antenna on to an electronic assembly of the motor vehicle door handle arrangement. After the mounting of the connection piece, the sensor plate, with the connection piece, can be pushed into its final mounting position, wherein the sensor plate and/or the connection piece preferably is/are fixed by engaging behind an undercut on the antenna carrier.

The sensor plate preferably comprises one or multiple recesses on one or both longitudinal edges, into which protrusions of the antenna carrier engage and releasably latch the sensor plate in a pre-mounting position. Alternatively or cumulatively, the antenna carrier can comprise one or multiple recesses, into which protrusions on one or both longitudinal edges of the sensor plate engage and releasably latch the sensor plate in a pre-mounting position.

Due to the preferred material combination of the sensor plate manufactured from metal and the antenna carrier manufactured from plastic material, the latching of the pre-mounting position can be released in a simple manner, and the sensor plate with the placed-on connection piece can be displaced into its final mounting position in the antenna carrier without damaging one or both of the components sensor plate or antenna carrier.

Accordingly, the sensor plate is pushed into its final mounting position together with the connection piece after the mounting of the connection piece, wherein the sensor plate and/or the connection piece preferably is/are fixed on the antenna carrier by engaging behind an undercut. Here, an undercut on the plug and/or on the sensor plate and/or on the antenna carrier is engaged behind by a corresponding counter part on the respective corresponding component.

The antenna carrier preferably further accommodates a ferromagnetic core and a coil which is wound around the core and/or the antenna carrier, in particular wherein the ferromagnetic core is arranged in the antenna carrier in a form-fit manner. The ferromagnetic core is fixed and securely held by the form-fit between the ferromagnetic core and the antenna carrier.

The antenna carrier preferably accommodates a ferromagnetic core, and the ferromagnetic core is inserted into a groove-shaped or dovetail-shaped receptacle of the antenna carrier in the direction of its longitudinal extension, in particular inserted into the receptacle in a direction opposite to the insertion direction of the sensor plate.

The term “insertion into opposite directions” means the movement direction in the respective assembly process here. Thus, the ferromagnetic core can be inserted into a corresponding receptacle of the antenna carrier for the core from the rear end of the antenna carrier, and the sensor plate can be inserted into a corresponding receptacle of the antenna carrier for the sensor plate from the front end of the antenna carrier, or vice versa. However, it is also possible to insert the ferromagnetic core of the antenna as well as the sensor plate of a capacitive proximity sensor into the same direction into respective corresponding receptacles of the antenna carrier.

The ferromagnetic core is preferably inserted into a groove-shaped or dovetail-shaped receptacle of the antenna carrier in the direction of its longitudinal extension. The ferromagnetic core is formed as a cuboid, wherein the extension in the longitudinal direction is significantly larger than into the other two dimensions perpendicular to its longitudinal extension. Accordingly, the term “insertion of the core in its longitudinal direction” means an insertion direction parallel to the longitudinal extension of the ferromagnetic core. For this purpose, the antenna carrier comprises, in a cross-sectional view, a correspondingly contoured receptacle. The mounting of the ferromagnetic core thus merely occurs through insertion into this receptacle of the antenna carrier. The receptacle of the antenna carrier can be configured in the shape of a groove or a dovetail.

Preferably, the ferromagnetic core is formed in two parts, in particular two parts equal in length in the direction of the longitudinal extension of the core, which are arranged one behind the other in the antenna carrier. The ferromagnetic core can be formed by two or more portions located one behind the other in the longitudinal direction. In particular, a separation of the core halfway in the longitudinal direction into two portions of equal length can be effected. A bending region or multiple bending regions are formed by a separation of the ferromagnetic core into two or multiple portions. A damage of the ferromagnetic core due to a slight deformation of the handle is prevented by means of such a bending region.

The antenna carrier preferably comprises at least one bending region, wherein the bending region is formed by a material cut-out. The bending regions formed by material cut-out are preferably positioned in such a way that they are aligned with the separating line of a separation of the core into multiple portions perpendicularly to the longitudinal extension of the ferromagnetic core. In other words, the separation of the core, forming a bending region of the core, and the bending region of the antenna carrier can be located in the same plane perpendicular to the longitudinal extension of the ferromagnetic core. The arrangement of such a bending region on the antenna carrier also serves to prevent damages due to a slight deformation of the handle.

A coil is preferably wound around the antenna carrier, in which the core is arranged.

The outer contour of the connection piece preferably comprises one or more recesses and/or grooves and/or protrusions, which serve as a positioning aid and/or seal during the insertion of the connection piece with the antenna carrier into an antenna chamber of the handle and cooperate with corresponding counterparts on the contour of the antenna chamber.

For this purpose, the contact pins can be overmolded with plastic material and thus form a connection piece, wherein the outer contour of the connection piece comprises one or multiple recesses and/or grooves and/or protrusions, which serve as a positioning aid and/or seal during the insertion of the connection piece with the antenna carrier into an antenna chamber of the handle, and which cooperate with corresponding counterparts on the contour of the antenna chamber. The contact pins preferably are overmolded with plastic material and form a connection piece, wherein the connection piece and the antenna carrier can be configured in one piece, in particular from the same material. Thus, connection piece and antenna carrier can be manufactured in one piece and in particular from the same material by a single plastic injection-molding process.

The handle preferably comprises an antenna chamber, in which at least the antenna carrier with the ferromagnetic core as well as the coil wound around the core and/or the antenna carrier is accommodated, and wherein the antenna chamber is potted with a potting material after the insertion of the antenna carrier. The antenna is protected against moisture and vibration by potting the antenna chamber with a curable potting material. The antenna chamber thus forms the installation chamber for accommodating the antenna in the handle, which is potted with a potting material after the insertion of the antenna.

The contact pins are preferably overmolded with plastic once, or repeatedly, and form a connection piece, a softer material, which serves as a seal of an antenna chamber and/or electronics chamber, can in particular be used in the second plastic overmolding process. Thus, the same plastic material or different plastic materials with different properties can be used in multiple plastic injection-molding processes. In a first plastic injection-molding process, a harder material can be used to form a stable connection piece. This pre-product can be overmolded with a softer plastic material in a second plastic injection-molding process, whereby a seal is formed on the outer side of the connection piece. This seal of the connection piece particularly serves preferably at least as a seal of an antenna chamber in the handle, in which the antenna is arranged.

The contact pins preferably are connected with a circuit board, in particular soldered with the circuit board, and the circuit board is accommodated in a trough. The circuit board can be equipped with electronic components.

The motor vehicle door handle arrangement preferably comprises a trough for accommodating a circuit board after the insertion of the contact pins and/or a circuit board, wherein the trough is filled with a potting material in particular after the reception of a pre-mounted circuit board, which is connected with the contact pins, in the trough. Particularly preferably, a seal which is arranged on the connection piece serves as a seal of the trough and is arranged in a recess of a wall of the trough in a form-fit manner. The seal of the connection piece can thus, in particular at the same time, form a seal of an antenna chamber and of a trough.

The handle preferably comprises an electronics chamber, in which a trough, with a circuit board received therein and/or a plug, are accommodated.

An exemplary embodiment of the invention is illustrated in the figures and will be explained hereinafter. The figures show in:

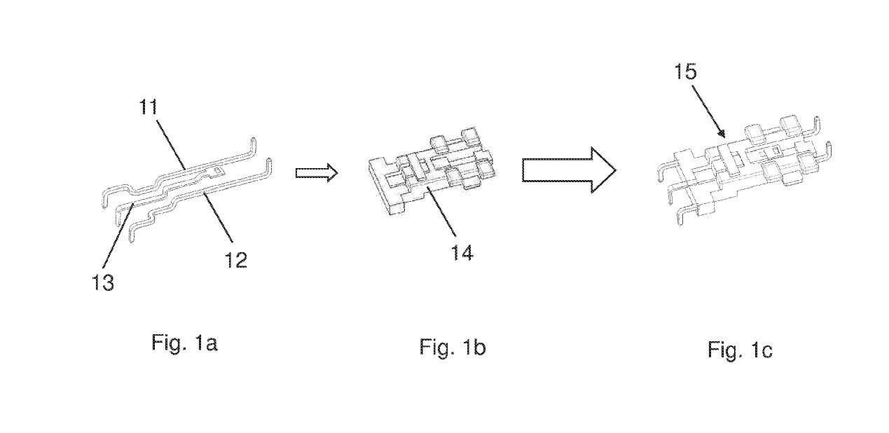

FIG. 1 the first manufacturing step during the overmolding of contact pins for the antenna and the proximity sensor;

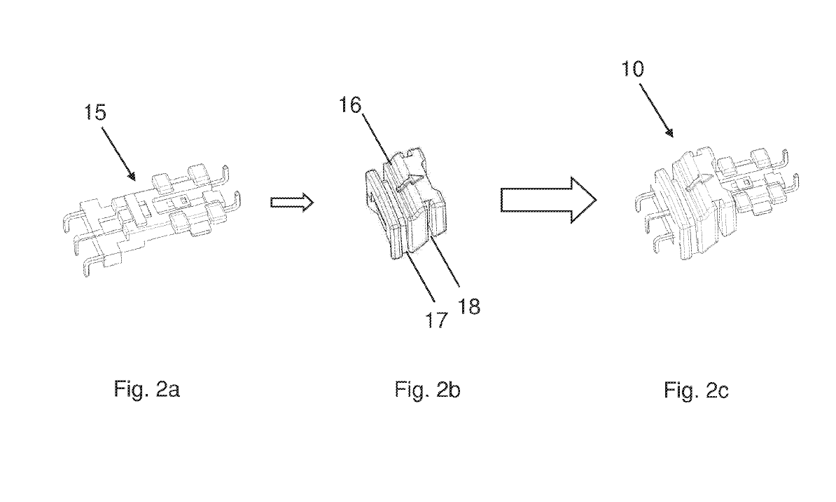

FIG. 2 the second manufacturing step with a further overmolding for the production of the connection piece for the antenna and the proximity sensor;

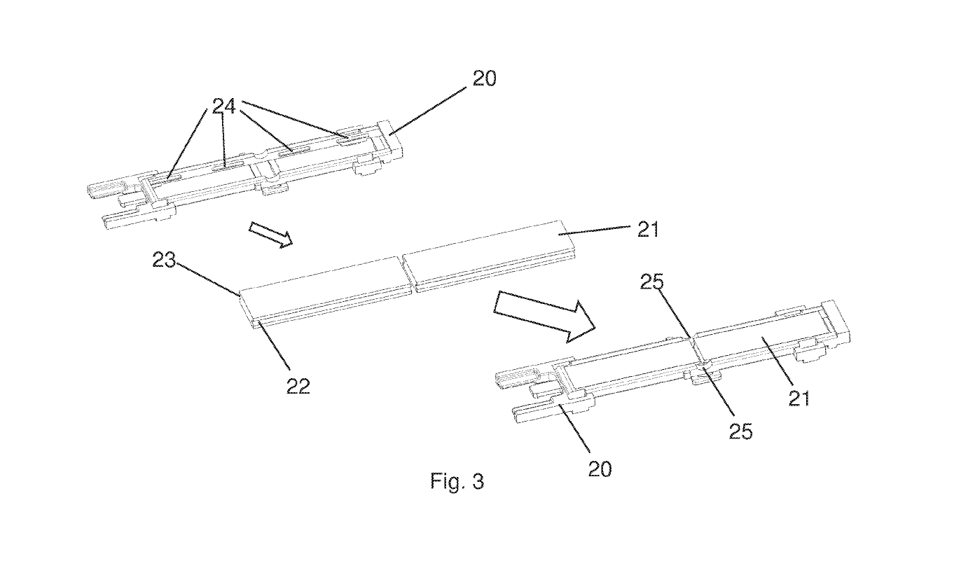

FIG. 3 the antenna carrier as well as the mounting of the ferromagnetic core in the antenna carrier;

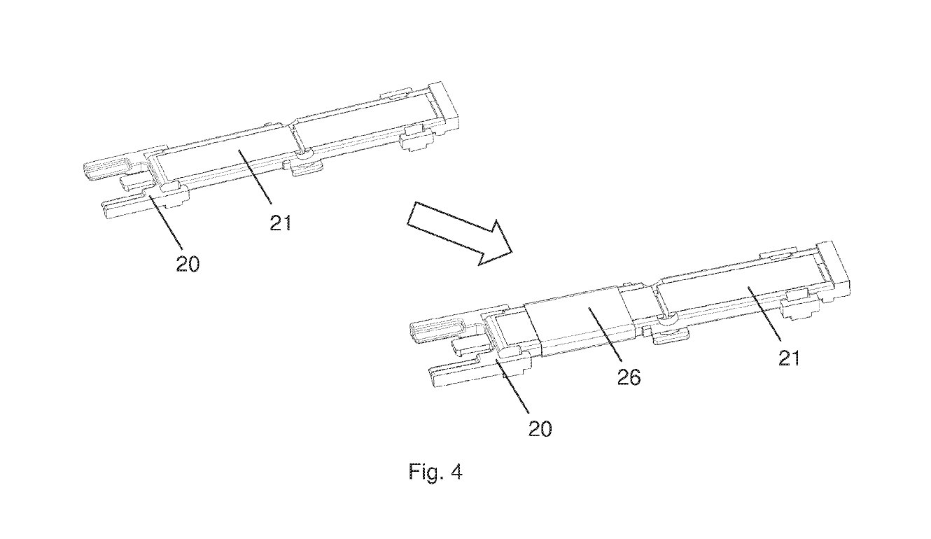

FIG. 4 the application of the winding on to the antenna carrier;

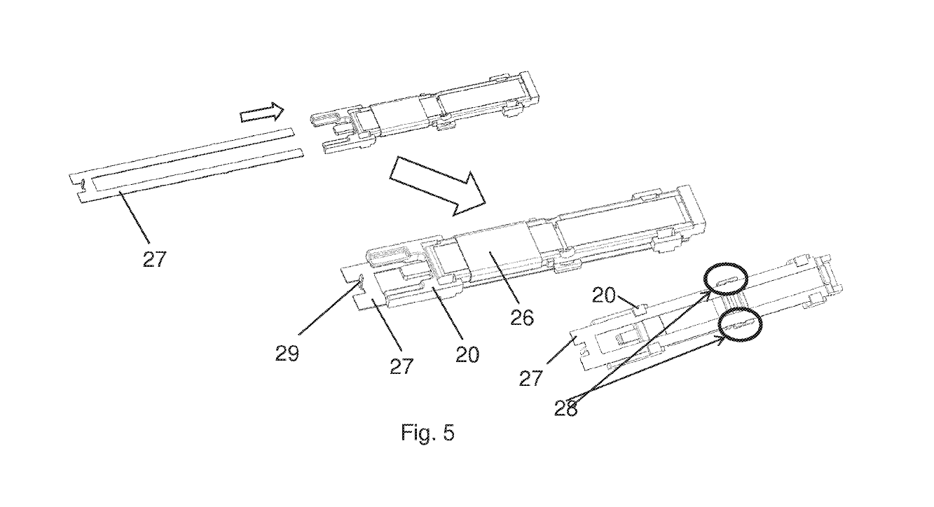

FIG. 5 the mounting of the sensor plate of the capacitive proximity sensor to the antenna carrier;

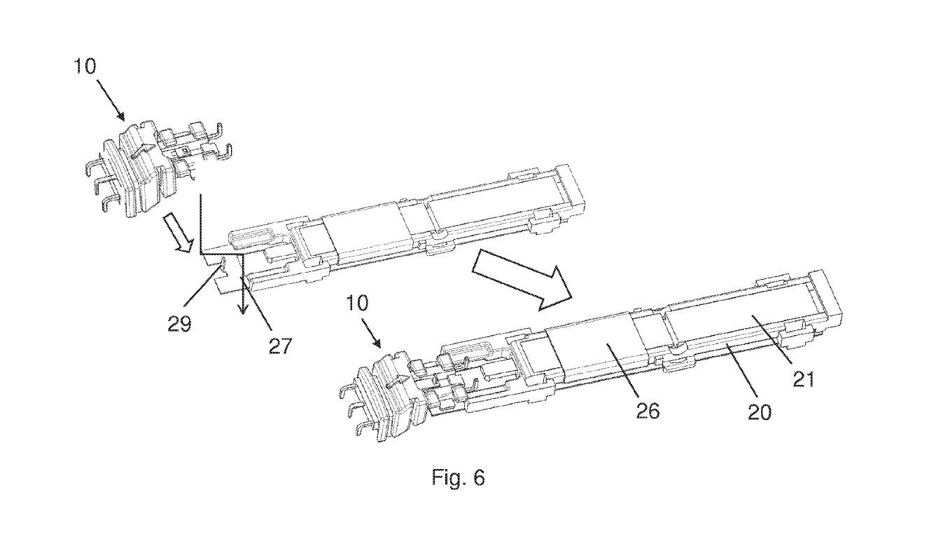

FIG. 6 the placement of the connection piece on the sensor plate at the antenna carrier;

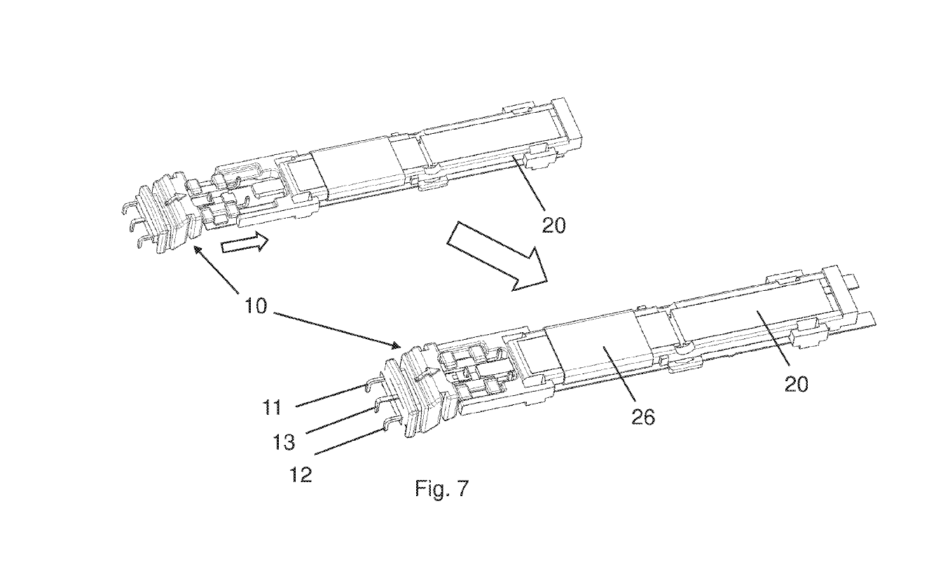

FIG. 7 insertion and mounting of the sensor plate, with the connection piece placed-on, in the antenna carrier;

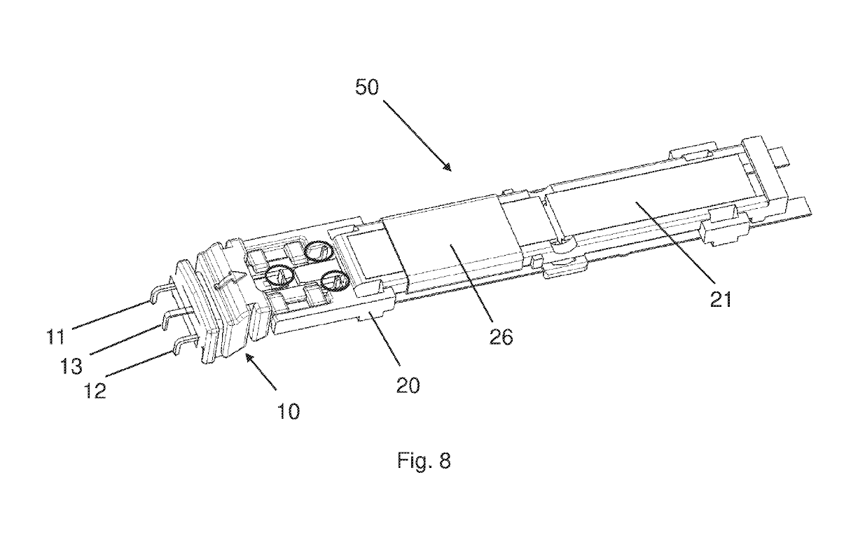

FIG. 8 the connection of the contact pins for the antenna and the proximity sensor on the solder points;

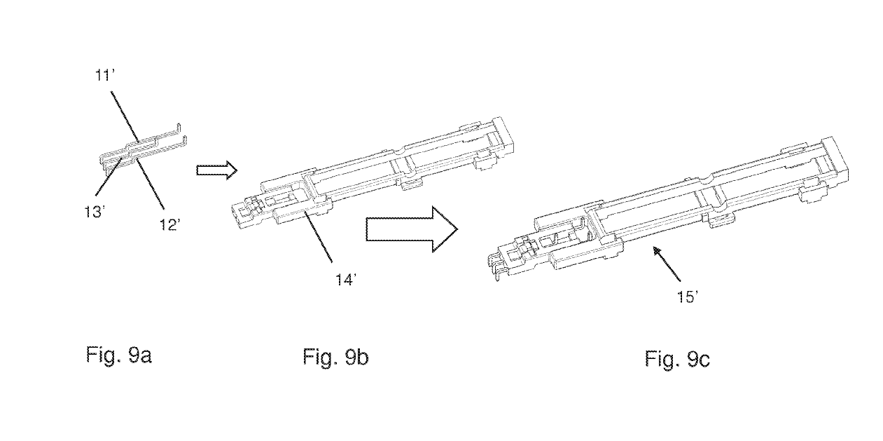

FIG. 9 an alternative configuration of overmolded contact pins for the production of an integral antenna carrier with connection piece;

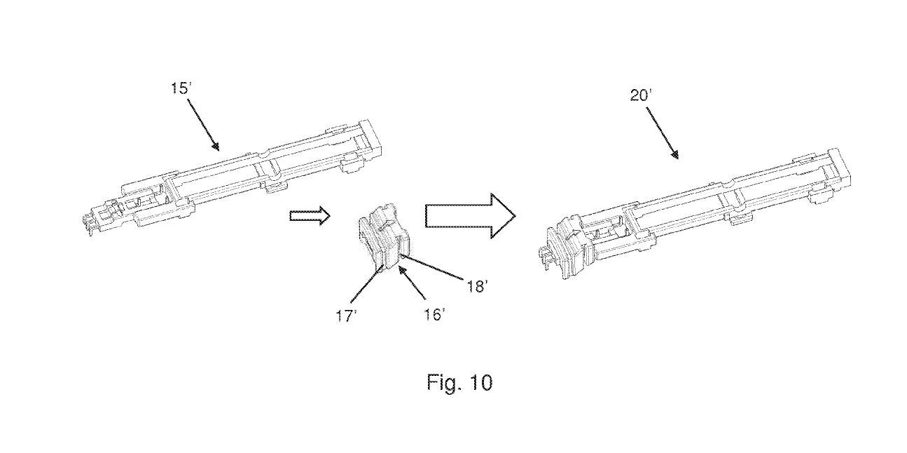

FIG. 10 a second plastic overmolding of the antenna carrier with connection piece of FIG. 9;

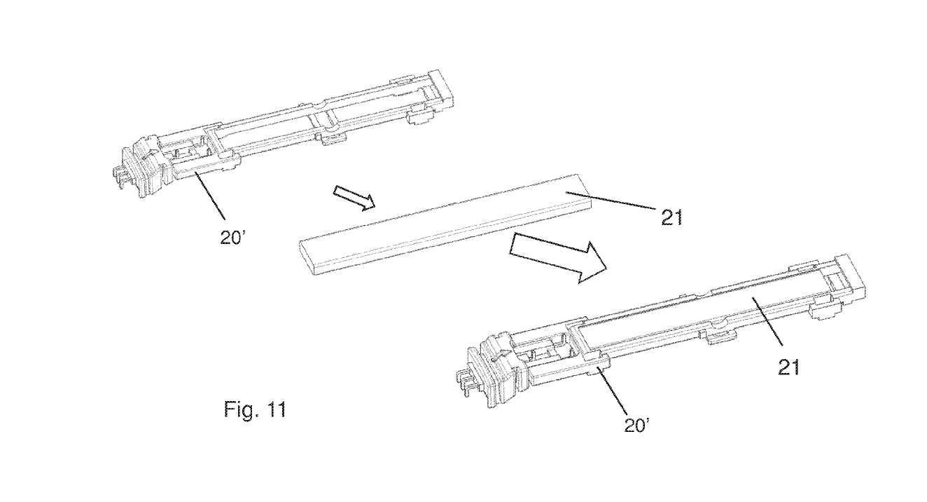

FIG. 11 the mounting of the ferromagnetic core on to the antenna carrier of FIG. 10;

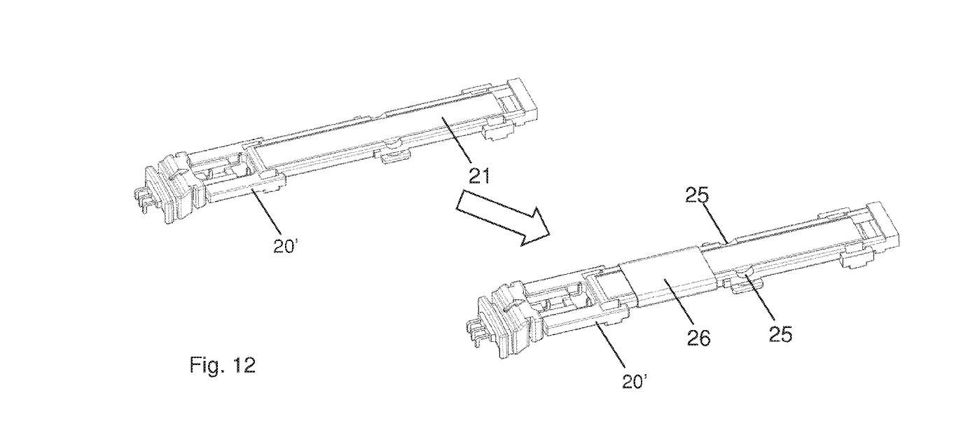

FIG. 12 the application of a winding on to the antenna carrier of FIG. 11;

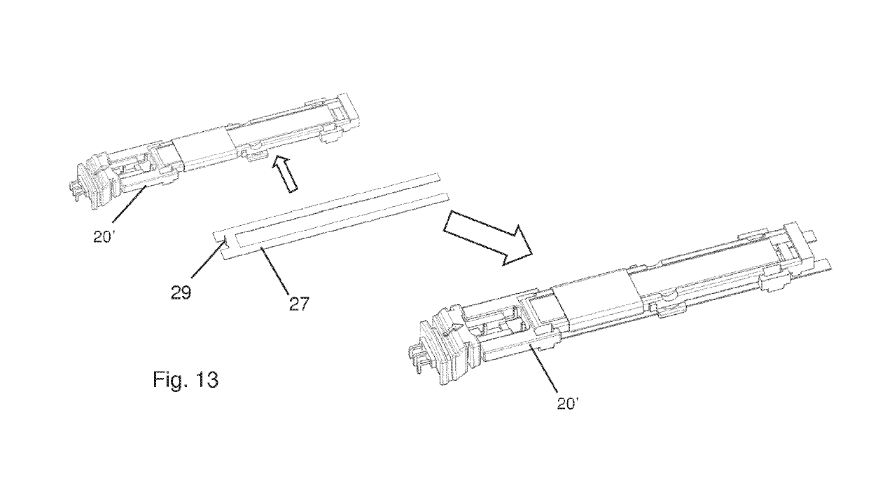

FIG. 13 the mounting of a sensor plate of a capacitive proximity sensor on the antenna carrier of FIG. 12;

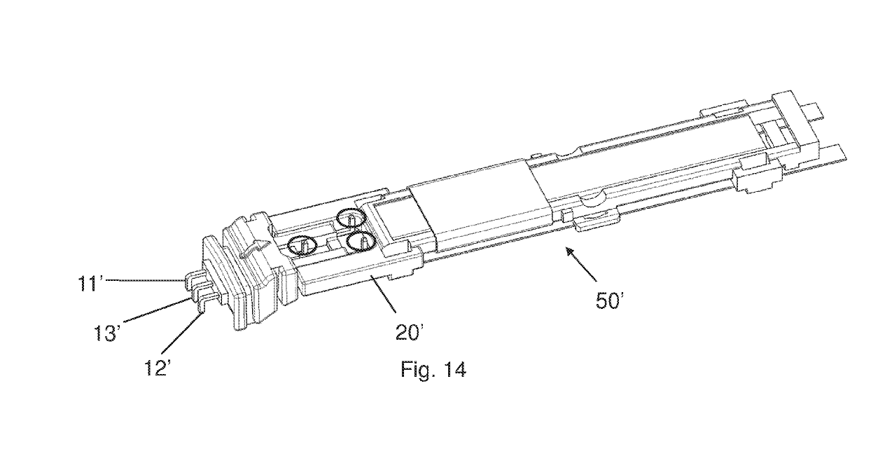

FIG. 14 the connection of the contact pins for the antenna and the proximity sensor on the corresponding solder points of the antenna carrier of FIG. 13;

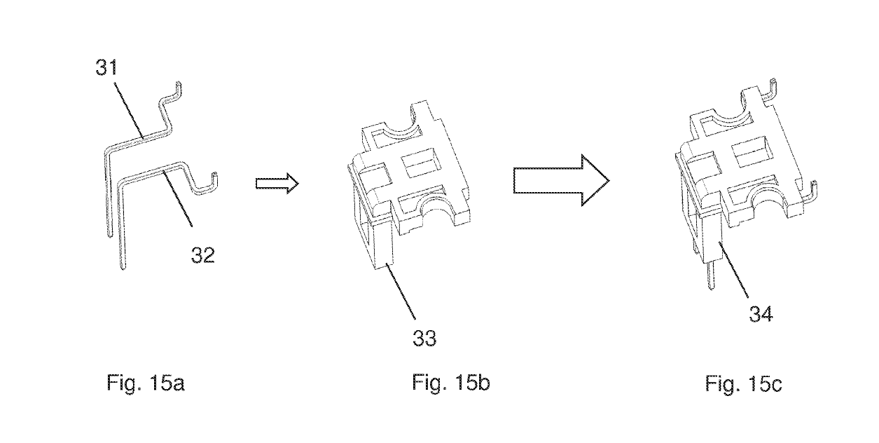

FIG. 15 the overmolding process of contact pins for the production of a plug;

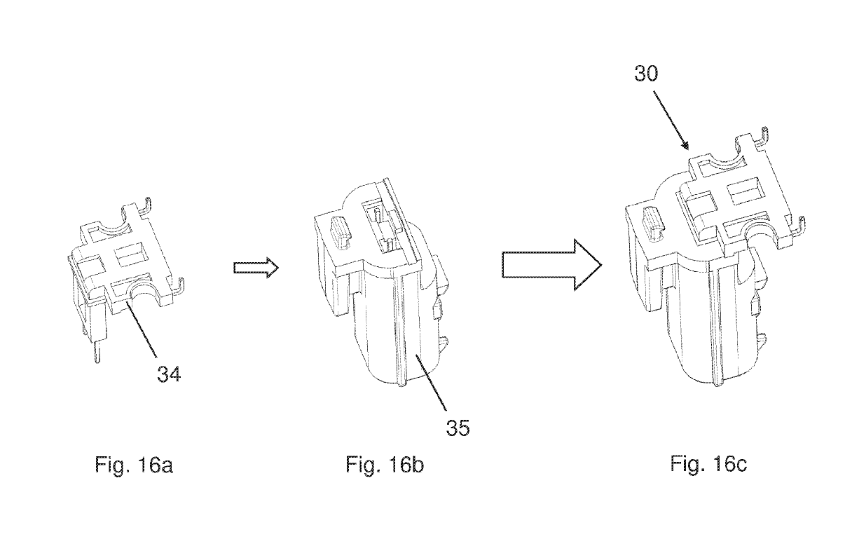

FIG. 16 the second plastic injection-molding process for the production of the plug;

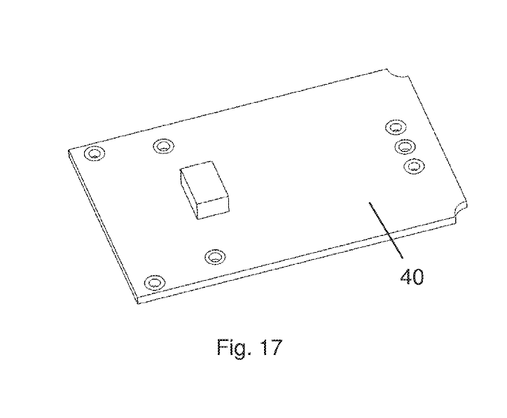

FIG. 17 the circuit board;

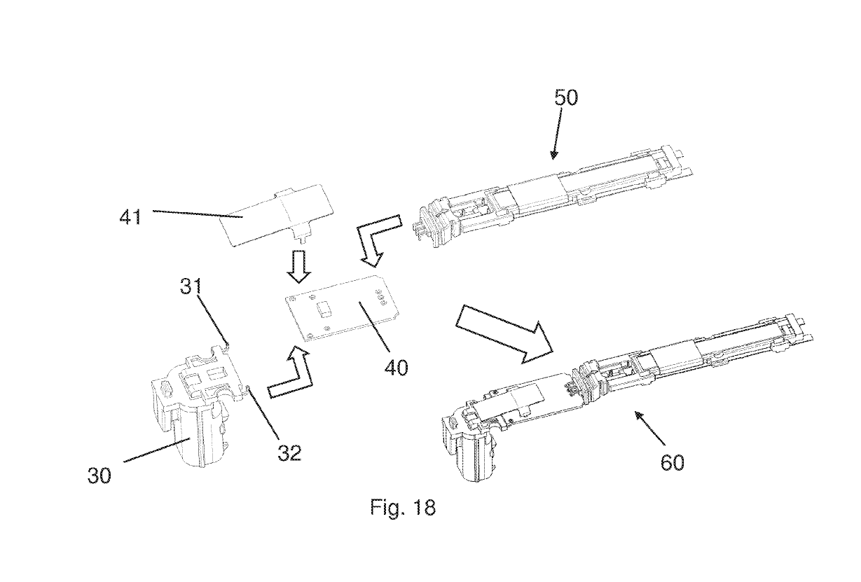

FIG. 18 the assembly of the plug as well as the antenna carrier and of the plate for locking the circuit board;

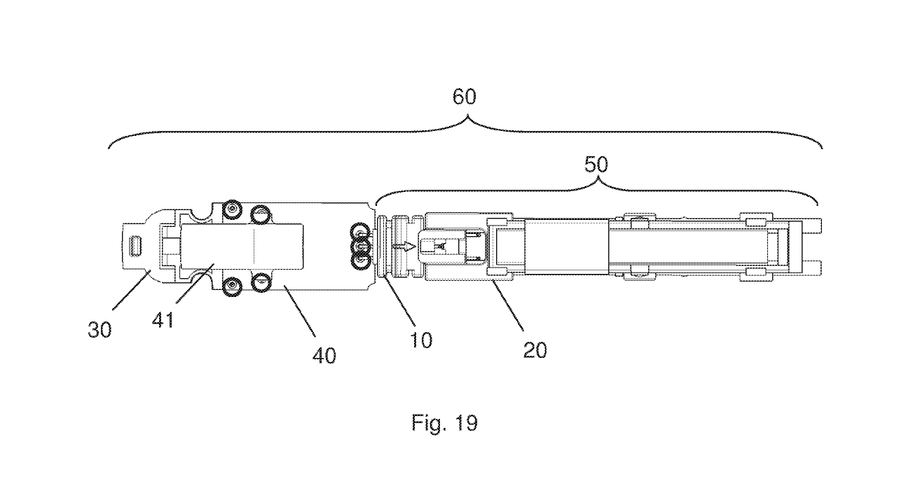

FIG. 19 the soldering points for soldering the contacts with the circuit board;

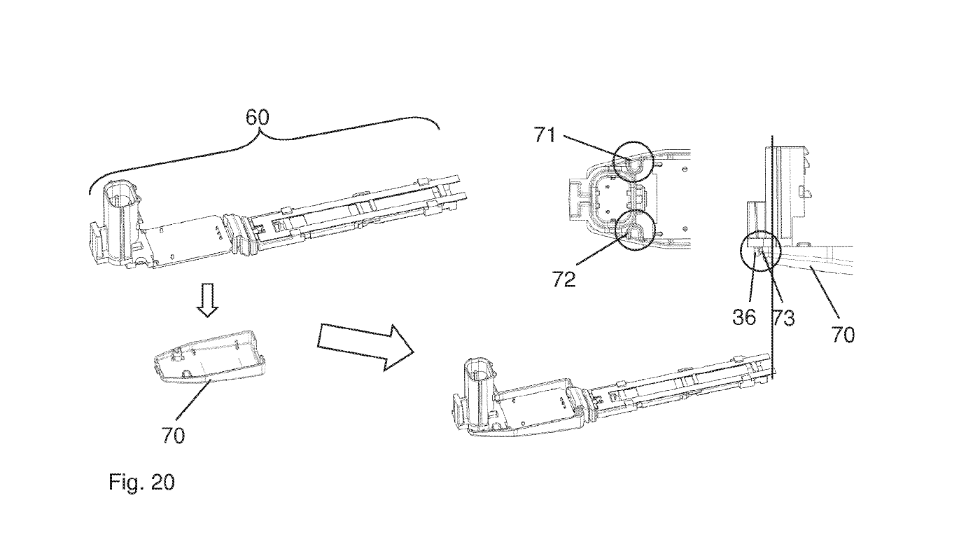

FIG. 20 the insertion of the circuit board into the trough;

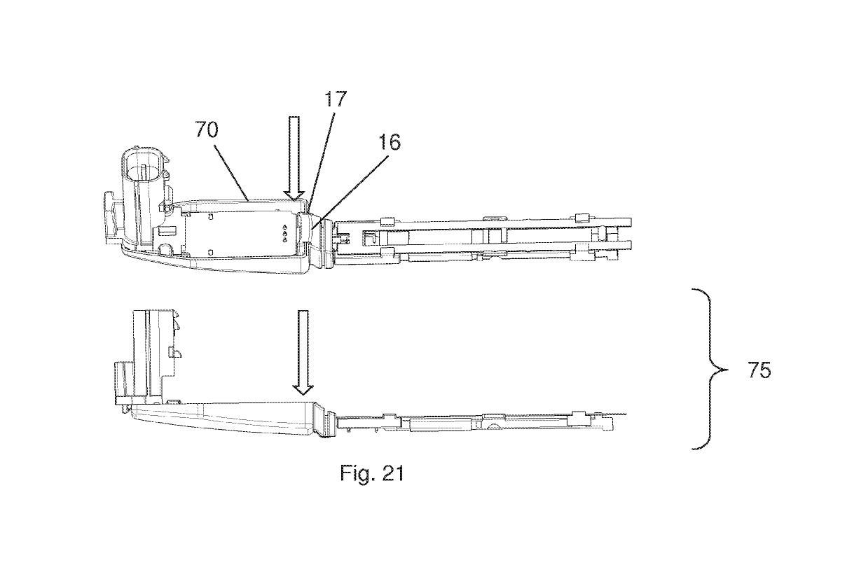

FIG. 21 the potting process when potting the trough with potting material;

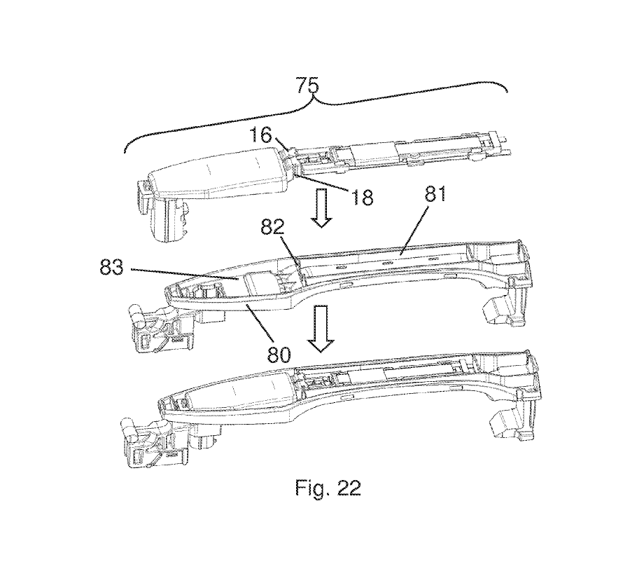

FIG. 22 the assembly of the electronic module in the handle and the insertion of the antenna in the antenna chamber;

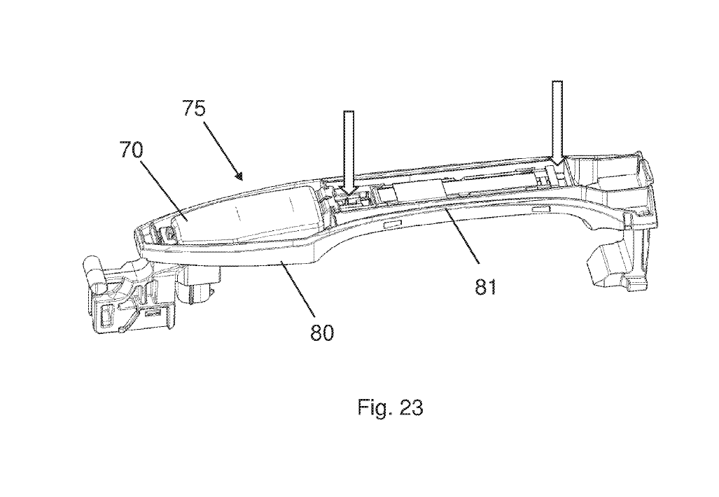

FIG. 23 the potting process when potting the antenna chamber with potting material;

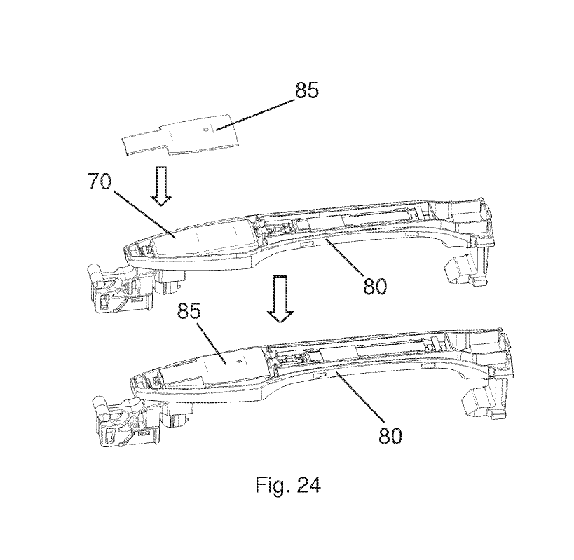

FIG. 24 the mounting of the pad on to the trough;

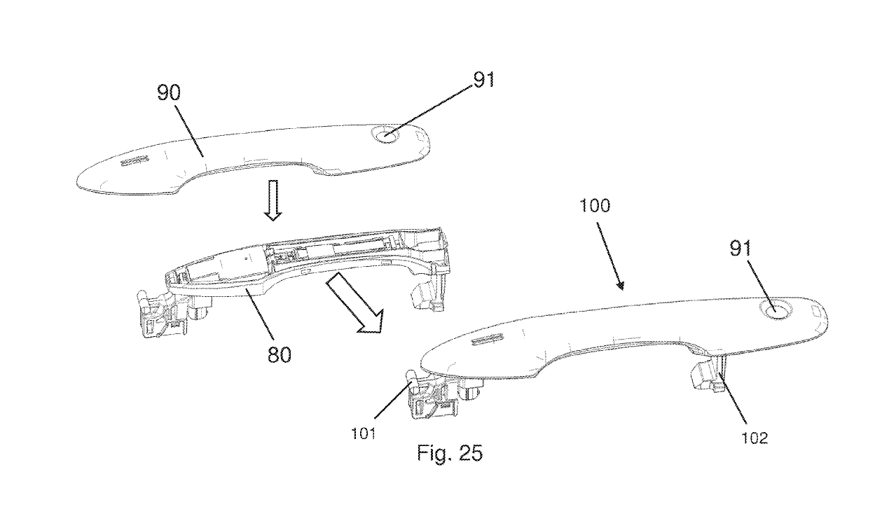

FIG. 25 the mounting process of the outer handle shell on to the handle.

The assembly method and production method for the production of such a motor vehicle door handle arrangement will hereinafter be explained at the same time based upon the following description of Figures.

FIG. 1a shows contact pins 11, 12, 13, which are overmolded with plastic in a first production step. The positive mold 14 of the first plastic overmolding of the contact pins 11, 12, 13 is shown in FIG. 1b. After the first method step of plastic overmolding of the contact pins 11, 12, 13 using the positive mold 14, the pre-product 15 of the connection piece is obtained, as shown in FIG. 1c.

In accordance with FIG. 2, the pre-product 15 shown in FIG. 2a is overmolded with plastic in a further method step using the positive mold 16 of FIG. 2b, to form the connection piece 10 of FIG. 2c. The positive mold 16 of the second overmolding process comprises, on the outer side, two grooves 17, 18 which extend across respectively three outer sides. The orientation of the two grooves 17, 18 extending across respectively three outer sides is in opposite direction. These grooves 17, 18 form sealing regions. The outer section 16 forms seals which cooperate with chambers, in which electronic components of the motor vehicle door handle arrangement are arranged, and which seal theses chambers. The assembling and mode of operation is explained below.

The contact pins 11, 12, 13 serve to couple the antenna as well as the sensor plate of the capacitive proximity sensor with the electronics of the motor vehicle door handle.

In the illustrated exemplary embodiment of FIGS. 1 and 2, the overmolding of the contact pins 11, 12, 13 occurs in two steps using different types of plastics. For the production of the pre-product 15 of FIG. 1, a harder plastic material is used. A second, softer plastic material is used for the production of the complete connection piece 10 in the second plastic injection-molding process using the positive mold 16, which second material is suitable to serve as a sealing element and which thusly has a greater deformability than the plastic material of the pre-product 15.

In an alternative, which is not illustrated, the connection piece 10 is produced in a single plastic injection-molding process using a plastic material suitable as a sealing element. In this case, the contact pins 11, 12, 13 are overmolded with the plastic material suitable as a seal in a single plastic injection-molding process.

FIG. 3 shows the antenna carrier 20 produced as a plastic injection-molded part, into which the ferromagnetic core 21 of the antenna is placed. The ferromagnetic core 21 is arranged in a form-fit manner in the antenna carrier 20 and, to that end, is inserted into the antenna carrier 20 from the right side in the image plane of FIG. 3. On the outer side, the ferromagnetic core 21 has grooves 22, 23, which are pushed over corresponding protrusions 24 on the inner side of the antenna carrier 20. By means of the protrusions 24 of the antenna carrier 20 which engage into the grooves 22, 23 of the ferromagnetic core 21, the ferromagnetic core 21 is arranged in a form-fit manner in the antenna carrier 20.

The ferromagnetic core 21 is divided in the middle thereof, and thus configured in two parts. The antenna carrier 20 comprises material cut-outs 25, which are aligned with the separating line between the two parts of the ferromagnetic core 21. Through the weakening 25 of the material of the antenna carrier 20 and the central separation of the ferromagnetic core 21, a bending region is generated, which is used to permit slight deformations of the antenna carrier 20 due to the actuation of the handle by a user without that this would lead to a damaging of the ferromagnetic core 21.

FIG. 4 shows the application of the winding 26 on to the antenna carrier 20 and the ferromagnetic core 21 arranged in the antenna carrier 20.

FIG. 5 shows the mounting of the sensor plate 27 of the capacitive proximity sensor in the antenna carrier 20. For this purpose, the sensor plate 27 is inserted into a corresponding receptacle on the antenna carrier 20 against the insertion direction of the ferromagnetic core 21, as shown in FIG. 5. For this purpose, the antenna carrier 20 comprises a corresponding receiving area on its bottom side, in which the sensor plate 27 is arranged after being mounted in the antenna carrier 20.

The sensor plate 27 and the antenna carrier 20 comprise latching elements 28 to latch the sensor plate 27 on the antenna carrier 20 in a pre-mounting position. This pre-mounting position of FIG. 5 serves to mount the connection piece 10, in that the recess on the sensor plate contact pin 13 of the connection piece 10 is placed on to the upwardly-bent contact 29 of the sensor plate 27, as shown in FIG. 6.

In the exemplary embodiment shown, the latching elements 28 are created by the outer-side lugs on the sensor plate 27, which engage into corresponding recesses in the lateral guidance for the sensor plate 27 on the antenna carrier 20 in the pre-mounting position of FIG. 5. Since the antenna carrier 20 is formed of a plastic injection-molded part and correspondingly comprises a reversible deformability, the sensor plate 27 can be inserted from the pre-mounting position of FIG. 5 further in the direction towards its final position easily and without damage to the sensor plate 27 or the antenna carrier 20. The latching elements can likewise be configured in a kinematically reversed manner, in that lugs on the lateral guidance for the sensor plate 27 on the antenna carrier 20 engage into correspondingly positioned recesses on the lateral edges of the sensor plate 27 in the pre-mounting position of the sensor plate 27.

After placing the contact 13 onto the upwardly-bent contact 29 of the sensor plate 27, the sensor plate 27 with the connection piece 10 placed thereon is inserted into the antenna carrier 20 into its final position in accordance with the representation in FIG. 7. In the final position of the sensor plate 27 with the connection piece 10 placed thereon, the antenna contact pins 11, 12 come into contact with the antenna.

FIG. 8 shows the soldering points in a circled manner. Accordingly, the contact pins 11, 12, 13 are soldered at the points marked in FIG. 8. As a result, a permanent electrically-conducting connection between the contact pins 11, 12, 13 and the antenna as well as the sensor plate 27 is established.

Thus, upon the soldering of the contact pins 11, 12, 13, a pre-assembled antenna assembly 50 is obtained from the antenna carrier 20 and the connection piece 10 attached thereto, as well as the above-described further components.

FIG. 9 shows an alternative configuration of the antenna carrier. In the alternative embodiment of FIG. 9, the contact pins 11′, 12′, 13′ are overmolded, in a first plastic injection-molding process, using the positive mold 14′ shown in FIG. 9. Accordingly, in the exemplary embodiment of FIG. 9, the antenna carrier including the base of the connection piece as a pre-product 15′, are produced in one piece and from the same material by plastic overmolding of the contact pins 11′, 12′, 13′.

As shown in FIG. 10, a second overmolding process using the positive mold 16′ is performed with a softer plastic material, which is suitable as a seal. Thus, the production of the antenna carrier 20′ with the sealing element 16′ configured in one piece as antenna carrier 20′ with integrated connection piece, the geometric design and function of which corresponds to the embodiment explained above on the basis of FIGS. 1 to 8 with regard to the grooves 17′, 18′ arranged on the outer side. Alternatively, overmolding of the contact pins 11′, 12′, 13′ can also occur in a single process with a plastic material suitable as a sealing element.

FIG. 11 shows the mounting of the ferromagnetic core 21 in the antenna carrier 20′.

According to FIG. 12, the winding 27 is now applied on to the antenna carrier 20′ and the ferromagnetic core 21. The antenna carrier 20′ in turn comprises material weaknesses 25 for the formation of a bending region. The ferromagnetic core 21 is likewise divided in the middle, so that the central separation of the ferromagnetic core 21 and the recesses 25 in the antenna carrier 20′ are aligned. In a non-illustrated alternative, the ferromagnetic core is configured in one piece.

According to FIG. 13, the sensor plate 27 of the capacitive proximity sensor is now inserted from below into the antenna carrier 20′. In this case, the insertion occurs from below, since an insertion from the front is not possible due to the integral configuration of the antenna carrier 20′ with the connection piece.

FIG. 14 in turn shows the soldering points for soldering the contact pins 11′, 12′, 13′ with the corresponding antenna contacts or the contact 29 on the sensor plate 27.

The antenna assembly 50′ composed of the antenna carrier 20′ and the connection piece, produced in accordance with FIGS. 9 to 14, corresponds to the final result of the antenna assembly 50 that has been produced in accordance with the previously-illustrated method steps of FIGS. 1 to 8.

The antenna of the antenna carrier assembly serves to remotely control the locking system by a user, and to forward the corresponding radio signals to the electronics on the circuit board 40 of FIG. 17, as will be explained below. The sensor plate 27 of the capacitive proximity sensor serves to detect the gripping behind the handle by a user, in order to thereby activate the electronics of the motor vehicle door handle arrangement.

A plug is provided for the coupling of the electronics of the motor vehicle door handle arrangement with the motor vehicle, the production of which plug is explained on the basis of FIGS. 15 and 16. For this purpose, contact pins 31, 32 of FIG. 15a are overmolded in a first plastic injection-molding process using the positive mold 33 of FIG. 15b to produce the pre-product 34 of FIG. 15c. After that, this pre-product 34, which is shown in FIG. 16a, is overmolded in a further plastic injection-molding process using the positive mold 35 of FIG. 1b, to produce the plug 30 according to FIG. 16c.

In this two-step plastic injection-molding process of FIGS. 15 and 16, different plastic materials are employed in the respective injection-molding process. In an alternative, which is not shown, the production process for the production of the plug 30 can occur in a single plastic injection-molding process during the overmolding of the contact pins 31, 32. In this case, the plug is made in one piece and from the same material.

FIG. 17 shows the circuit board 40, equipped with the electronic components, of the motor vehicle door handle arrangement. The equipped circuit board 40 serves for processing and forwarding the signals of the antenna as well as of the sensor plate 27, and for coupling with the vehicle electronics via the plug 30.

FIG. 18 shows the process of mounting the plug 30 by placing-in from below into the circuit board 40, as well as the mounting of the pre-assembled antenna assembly 50 on the circuit board 40. The plug 30 is mounted by plugging-in from below into the circuit board 40 into corresponding contact points. The mounting occurs through the plugging-in of the contact pins 31, 32 from below into corresponding through-openings in the circuit board 40.

The antenna assembly 50, in turn, is plugged into corresponding recesses of the circuit board 40 from the upper side. The mounting occurs by the plugging-in of the contact pins 11, 12, 13 of the antenna assembly 50 from above into corresponding through-openings in the circuit board 40.

As a result, the coupling of the contact pins 31, 32 of the plug 30 with the circuit board as well as further the coupling of the contact pins 11, 12, 13 of the antenna assembly 50 with the circuit board 40 follows. Furthermore, a locking plate 41 with contact pins is placed on to the circuit board 40 from above and inserted into corresponding receptacles of the circuit board 40. As a result, the module 60 composed of the antenna assembly 50 including the antenna and the winding as well as the connection piece, the circuit board 40 and the plug 30, is achieved, as shown in FIG. 18. In this module 60, the circuit board 40 thus forms a load-bearing component of the electronics module 60.

FIG. 19 shows the soldering points for the connection of the contact pins 11, 12, 13, 31, 32, as well as of the plate 41 for the locking on the circuit board 40. The soldering points are marked with circles in FIG. 19. The soldering of all contact points on the circuit board 40 occurs on the upper side of the circuit board 40, as shown in FIG. 19. In other words, the soldering of the contact pins on the circuit board 40 occurs from the same side, although the plug 30 is plugged into the circuit board 40 from another side than the antenna assembly 50 and the locking plate 41. Thus, the production process of the electronic module 60 is completed by the process of soldering the contact points on the circuit board 40.

The module 60 thus includes the antenna carrier 20, which receives the antenna with the ferromagnetic core and the coil, as well as the sensor plate, the connection piece 10, through which electrically-conducting contact pins are guided from the antenna and the sensor plate to the circuit board 40 equipped with the electronic components, and are connected to this board, wherein the circuit board 40 is further connected with the plug 30, which serves to produce the electrical contacts for the electronic assembly of the module 60, and wherein the circuit board 40 is connected with the electrical contact pins of the plug. The circuit board 40 forms a load-bearing component of the module 60 here.

FIG. 20 shows the further mounting of the pre-assembled electronic assembly in the form of the module 60 with the placing-in into the trough 70, which serves to accommodate the circuit board 40. The trough 70 thus completely receives the circuit board 40 including the soldered contacts. For the positioning of the electronic assembly 60 in the trough 70, the trough 70 comprises corresponding positioning aids 71, 72, which form a form-fit with corresponding recesses on the peripheral edges of the circuit board 40. Thus, the positioning of the module 60 occurs through the positioning aids 71, 72 on the trough 70, which form a form-fit with corresponding counter-parts on the circuit board 40. The fixing of the entire arrangement is effected in that a lug 73 on the trough 70 engages behind an undercut 36 on the plug 30. The trough 70 is being fixed to the plug 30 by this clipping in accordance with FIG. 20. The positioning aids 71, 72 and the lug 73 on the trough 70 as well as the undercut 36 on the plug 30 are shown in an enlarged detailed view of FIG. 20.

In the exemplary embodiment shown, the positioning aids 71, 72, which form a form-fit, are formed by bulges on the inner side of the trough 70, which engage into recesses on the peripheral edges of the circuit board 40. A reverse configuration is likewise possible, in which one or multiple lugs or projections on the peripheral edges of the circuit board engage into corresponding recesses of the trough, and thereby produce a form-fit which serves as a positioning and mounting aid.

The potting process of the trough 70 with the circuit board 40 arranged therein is shown in FIG. 21. In this potting process, the trough 70 with the circuit board 40 arranged therein is being potted with a curing potting material. This potting material serves to protect the electronic components of the circuit board 40 in the trough 70, and thus forms a protection against moisture as well as a damping element against vibration at the same time.

The sealing of the trough 70 occurs through the seal 16. The trough 70 comprises a recess, in which the seal 16 with the groove 17 is arranged in a form-fit and force-fit manner. The wall of the trough 70 is arranged in groove 17 of the seal 16 in a form-fit manner. At the same time, a clamping effect between the wall of the trough 70 and the seal 16 is generated. For this purpose, the seal 16 is formed from a plastic material which is suitable as a seal and reversibly deformable. The trough groove 17 of the seal 16 and the recess of the trough 70 are adapted to one another accordingly. The trough groove 17 thus forms a positioning aid during the placing-in of the circuit board 40 of the electronic module 60 into the trough 70. Through the clamping effect of the seal 16 in the recess of the wall of the trough 70, the circuit board 40 is, at the same time, secured and fixed against floating during the potting process. The potting material cures after the potting process. The potting material forms a protection of the circuit board 40 and of the soldered contacts against moisture. Furthermore, the potting material serves as a damper against vibration.

With the potting material cured in the potted trough 70, the electronics assembly 75 is obtained for the further mounting in the handle of the motor vehicle door handle arrangement. The mounting of the assembly 75 in the handle 80 of the motor vehicle door handle arrangement is explained on the basis of FIG. 22.

The pre-assembled assembly 75 including the trough 70 potted with the potting material, and the plug 30, is inserted into the handle 80 in reverse orientation, as can be discerned in FIG. 22. The placing-in occurs in such a way that the antenna assembly 50 in the antenna chamber 81 is arranged in the handle 80, while the trough 70 is arranged in the electronics chamber 83 in the handle 80 at the same time.

The sealing of the antenna chamber 81 in the handle 80 likewise occurs by means of the seal 16. The wall of the antenna chamber 81 comprises a recess 82, in which the seal 16 with the groove 18 is arranged in a form-fit and force-fit manner. The seal 16 comprises the second groove 18, which serves as an antenna chamber groove, on the outer side. The antenna chamber groove 18 is formed as a circumferential groove on the outer side on the seal 16, just like the trough groove 17 is. Due to the fact that the orientation during the insertion of the seal 16 into the trough 70 is opposite to the orientation during the insertion of the seal 16 into the antenna chamber, the grooves 17, 18 of the seal 16, which extend across respectively three outer sides of the seal 16, are also arranged in opposite directions.

The wall of the antenna chamber 81 is arranged in the groove 18 of the seal 16 in a form-fit manner. At the same time, a clamping effect between the wall of the antenna chamber 81 and the seal 16 is produced. For this purpose, the seal 16 is formed, as explained above, from a reversibly deformable plastic material which is suitable as a seal. The antenna chamber groove 18 of the seal 16 and the recess 82 of the antenna chamber 81 are adapted to one another accordingly. Thus, the antenna chamber groove 18 at the same time forms a positioning aid during the insertion of the antenna assembly 50 of the electronic module 60 into the antenna chamber 81. At the same time, the antenna assembly 50 is secured and fixed against floating during the potting process, which is explained below, by means of the clamping effect of the seal 16 in the recess 82 of the wall of the antenna chamber 81. The potting material cures after the potting process.

After the insertion of the pre-assembled assembly into the handle 80, the antenna chamber 81 is potted with a potting material, as indicated in FIG. 23. As the trough 70 is reversibly oriented now, it can be discerned that the potting of the trough 70 and of the antenna chamber 81 occurs from opposite directions. The potting of the antenna chamber 81 with potting material in turn serves to protect the antenna assembly 50 against moisture and vibration, since the potting material cures in the antenna chamber 81. The potting material thus forms a protection of the antenna assembly 50 and the soldered contacts against moisture. Furthermore, the potting material serves as a damper against vibration.

Subsequently, a flexible pad 85 is bonded on to the trough 70, as can be discerned in FIG. 24. The pad 85 serves for the sealing against water and ensures the functioning of the capacitive sensor plate 41 for the unlocking. As can be discerned in FIG. 24, the largest part of the trough 70 is covered by the pad 85. Possible is both, a covering of the trough 70 over the entire surface, and a partial covering of the trough 70 by the pad 85. The flexible pad 85 serves the dampening of vibration at the same time.

Subsequently, the outer shell 90 is mounted on the handle 80, as shown in FIG. 25. The rotary axis 101 can also be discerned in FIG. 25, around which the entire arrangement of FIG. 25 can be rotated in the mounted state. For this purpose, the entire handle arrangement 100 is mounted in a corresponding receptacle in the body of a motor vehicle. The handle arrangement 100 illustrated in FIG. 25 is mounted in a corresponding housing, or directly into the motor vehicle body. The rotary axis 101 of the handle arrangement 100 is usually located at the front in the direction of travel, so that the handle hook 102 on the rear end of the handle arrangement 100 can be pulled towards the outer side of the motor vehicle, and acts on the door lock via a corresponding coupling, and makes an opening of the motor vehicle door possible if the door lock is unlocked. However, the arrangement of the handle arrangement 100 of FIG. 25 is arbitrary. In particular, the arrangement can also be made reversibly on the motor vehicle, or vertically.

Furthermore, the outer shell 90 comprises a recess 91, through which a key can be inserted into a lock, which is not shown in FIG. 25. In the mounted state, the door lock of the motor vehicle is located aligned behind the recess 91 of the outer shell 90.

### LIST OF REFERENCE CHARACTERS

10 connection piece
11, 12, 13 contact pins
11′, 12′, 13′ contact pins
14, 14′ positive plastic injection mold
15, 15′ pre-product of connection piece
16, 16′ seal
17, 17′ trough groove
18, 18′ antenna chamber groove
20, 20′ antenna carrier
21 ferromagnetic core
22, 23 grooves
24 protrusion
25 recess
26 winding
27 sensor plate
28 latching elements
29 contact
30 plug
31, 32 contact pins
33 positive plastic injection mold
34 pre-product of the plug
35 positive plastic injection mold
36 undercut
40 circuit board
41 locking plate
50, 50′ antenna assembly
60 electronics module
70 trough
71, 72 positioning aids
73 lug
75 electronics assembly
80 handle
81 antenna chamber
82 wall
83 electronics chamber
85 pad
90 shell
91 recess
100 handle arrangement
101 rotary axis
102 handle hook

1-15. (canceled)

16. A motor vehicle door handle arrangement with a handle, wherein at least one antenna carrier is arranged in the handle, which accommodates at least one sensor plate of a capacitive proximity sensor, and wherein the sensor plate is connected, via contact pins, with a connection piece for producing electrical contacts, wherein the sensor plate is arranged in the antenna carrier in a form-fit manner and is inserted into a groove-shaped or dovetail-shaped receptacle of the antenna carrier in the direction of its longitudinal extension, wherein the sensor plate and/or the antenna carrier comprise(s) a latching connection, in which the sensor plate is releasably latched in a pre-mounting position, in order to make the mounting of the connection piece on the sensor plate possible.

17. The motor vehicle door handle arrangement according to claim 16, wherein the sensor plate comprises one or multiple recesses on one or both longitudinal edges, into which protrusions of the antenna carrier engage and releasably latch the sensor plate in a pre-mounting position.

18. The motor vehicle door handle arrangement according to claim 16, wherein the antenna carrier comprises one or multiple recesses, into which the protrusions on one or both longitudinal edges of the sensor plate engage and releasably latch the sensor plate in a pre-mounting position.

19. The motor vehicle door handle arrangement according to claim 16, wherein the sensor plate with the connection piece is inserted into its final mounting position after the mounting of the connection piece, wherein the sensor plate and/or the connection piece is/are fixed by engaging behind an undercut on the antenna carrier.

20. The motor vehicle door handle arrangement according to claim 16, wherein the antenna carrier further accommodates a ferromagnetic core and a coil wound around the core and/or the antenna carrier, in particular wherein the ferromagnetic core is arranged in the antenna carrier in a form-fit manner.

21. The motor vehicle door handle arrangement according to claim 16, wherein the antenna carrier accommodates a ferromagnetic core, and the ferromagnetic core is inserted into a groove-shaped or dovetail-shaped receptacle of the antenna carrier in the direction of its longitudinal extension, in particular is inserted into the receptacle in a direction opposite to the insertion direction of the sensor plate.

22. The motor vehicle door handle arrangement according to claim 16, wherein the antenna carrier accommodates a ferromagnetic core, and the ferromagnetic core is formed by two parts, in particular two parts equal in length in the direction of the longitudinal extension of the core which are arranged one behind the other in the antenna carrier.

23. The motor vehicle door handle arrangement according to claim 16, wherein the antenna carrier comprises at least one bending region, wherein the bending region is formed by a material cut-out.

24. The motor vehicle door handle arrangement according to claim 16, wherein a coil is wound around the antenna carrier, in which a ferromagnetic core is arranged.

25. The motor vehicle door handle arrangement according to claim 16, wherein the outer contour of the connection piece comprises one or multiple recesses and/or grooves and/or protrusions, which serve as a positioning aid and/or seal during the insertion of the connection piece with the antenna carrier into an antenna chamber of the handle, and cooperate with corresponding counterparts on the contour of the antenna chamber.

26. The motor vehicle door handle arrangement according to claim 16, wherein the handle comprises an antenna chamber, in which at least the antenna carrier with the sensor plate, a ferromagnetic core as well as a coil wound around the core and/or the antenna carrier is accommodated, and wherein the antenna chamber is potted with a potting material after the insertion of the antenna carrier.

27. The motor vehicle door handle arrangement according to claim 16, wherein the connection piece is produced by one-time or repeated plastic overmolding of prefabricated contact pins, in particular in that a softer material, which serves as a seal, is used in a second plastic overmolding process.

28. The motor vehicle door handle arrangement according to claim 16, wherein the contact pins are connected, in particular soldered, with a circuit board, in particular in that the circuit board is accommodated in a trough.

29. The motor vehicle door handle arrangement according to claim 16, wherein a trough for accommodating a circuit board is filled with a potting material after the insertion of the connection piece and/or a circuit board, in particular after the reception of a pre-mounted circuit board, which is connected with the connection piece, in the trough.

30. The motor vehicle door handle arrangement according to claim 16, wherein the handle comprises an electronics chamber, in which a circuit board, in particular a trough with a circuit board received therein and/or a connection piece, are accommodated.
